(19) United States
(12) Patent Application Publication
(10) Pub. No.: US 2023/0332312 A1
(43) Pub. Date: Oct. 19, 2023

(54) SYSTEM AND METHOD FOR CONTROLLING HYDROGEN PRODUCTION BASED ON POWER PRODUCTION AND/OR POWER CONSUMPTION

(71) Applicant: Ohmium International, Inc., Incline Village, NV (US)

(72) Inventors: Chockkalingam Karuppaiah, Fremont, CA (US); Rasool Aghatehrani, Redwood City, CA (US); Anil Kumar Adapa, Tadepalligudem (IN)

(21) Appl. No.: 18/135,724

(22) Filed: Apr. 17, 2023

Related U.S. Application Data
(60) Provisional application No. 63/332,150, filed on Apr. 18, 2022.

(51) Int. Cl. C25B 15/02; H02J 13/00; C25B 9/65; C25B 1/04

(52) U.S. Cl. CPC C25B 15/02; H02J 13/00022; C25B 9/65; C25B 1/04

(57) ABSTRACT

Systems and techniques are described herein for controlling hydrogen production. For instance, a method for controlling hydrogen production is provided. The method may include determining an amount of power for a hydrogen-production installation to consume based on one or both of an amount of power produced by a power producer or an amount of power consumed by a power consumer; and controlling hydrogen production at one or more electrolyzers of the hydrogen-production installation such that the one or more electrolyzers consume substantially the determined amount of power.

### CROSS-REFERENCE TO RELATED APPLICATIONS

This application claims priority to U.S. Provisional Application No. 63/332,150 entitled “ADDITIONAL ACTIVE POWER SUPPORT SYSTEM”, filed Apr. 18, 2022, the entire contents of which are incorporated by reference herein.

### FIELD

The present disclosure relates to systems and methods for controlling hydrogen production based on adjacent power production and/or power consumption. For example, some embodiments of the present disclosure relate to controlling hydrogen production at a hydrogen-production installation based on power production and/or power consumption at one or more power producers or power consumers that are adjacent to the hydrogen-production installation.

### BACKGROUND

Power-producing (and/or power-distributing) entities, which may be referred to herein as “utilities,” may generate electrical power (e.g., at generators) and provide the electrical power to consumers as alternating-current (AC) power through a power grid. Power consumers (e.g., at a number of industrial and/or residential sites) may act as loads receiving the AC power from the power grid and consuming the AC power. Additionally, power producers (e.g., at a number of industrial and/or residential sites) may provide produce electrical power and provide the electrical power to the power grid in the form of AC power. For example, a solar farm (or a residential or commercial building with one or more solar panels on the roof) may provide AC power to the power grid.

The AC power in the power grid may exhibit a frequency. One or more generators of the utilities may include rotors that may spin at a rate related to the frequency. Utilities may control the frequency of the AC power on the power grid to keep the frequency substantially at a target frequency. Power consumption by power consumers and/or production by power producers may affect the frequency of the AC power. For example, a large load suddenly coming online may draw power from the power grid, which may decrease the frequency of the AC power of the power grid. A utility may cause one or more generators to generate additional power to compensate for the addition of large load, to return the frequency of the AC power on the power grid to the target frequency. Alternatively, if a large load suddenly goes offline, the generators may be producing more power than is being consumed, which may cause the frequency of the AC power of the power grid to increase. A utility may cause one or more generators to decrease the rate at which the one or more generators are providing power to the power grid to compensate for the removal of large load, to return the frequency of the AC power on the power grid to the target frequency.

### BRIEF SUMMARY

The following presents a simplified summary relating to one or more embodiments disclosed herein. Thus, the following summary should not be considered an extensive overview relating to all contemplated embodiments, nor should the following summary be considered to identify key or critical elements relating to all contemplated embodiments or to delineate the scope associated with any particular embodiment. Accordingly, the following summary presents certain concepts relating to one or more embodiments relating to the mechanisms disclosed herein in a simplified form to precede the detailed description presented below.

Systems and techniques are described for controlling hydrogen production. According to at least one example, a method is provided for controlling hydrogen production. The method includes: determining an amount of power for a hydrogen-production installation to consume based on one or both of an amount of power produced by a power producer or an amount of power consumed by a power consumer; and controlling hydrogen production at one or more electrolyzers of the hydrogen-production installation such that the one or more electrolyzers consume substantially the determined amount of power.

In another example, an apparatus for controlling hydrogen production is provided that includes at least one memory and at least one processor (e.g., configured in circuitry) coupled to the at least one memory. The at least one processor configured to: determine an amount of power for a hydrogen-production installation to consume based on one or both of an amount of power produced by a power producer or an amount of power consumed by a power consumer; and control hydrogen production at one or more electrolyzers of the hydrogen-production installation such that the one or more electrolyzers consume substantially the determined amount of power.

In another example, a non-transitory computer-readable medium is provided that has stored thereon instructions that, when executed by one or more processors, cause the one or more processors to: determine an amount of power for a hydrogen-production installation to consume based on one or both of an amount of power produced by a power producer or an amount of power consumed by a power consumer; and control hydrogen production at one or more electrolyzers of the hydrogen-production installation such that the one or more electrolyzers consume substantially the determined amount of power.

In another example, an apparatus for controlling hydrogen production is provided. The apparatus includes: means for determining an amount of power for a hydrogen-production installation to consume based on one or both of an amount of power produced by a power producer or an amount of power consumed by a power consumer; and means for controlling hydrogen production at one or more electrolyzers of the hydrogen-production installation such that the one or more electrolyzers consume substantially the determined amount of power.

In another example, a method is provided for controlling hydrogen production. The method includes: determining a frequency of alternating-current power provided by a power grid to a hydrogen-production installation; determining an amount of power for the hydrogen-production installation to consume based on the frequency; and controlling hydrogen production at one or more electrolyzers of the hydrogen-production installation such that the one or more electrolyzers consume substantially the determined amount of power.

In another example, an apparatus for controlling hydrogen production is provided that includes at least one memory and at least one processor (e.g., configured in circuitry) coupled to the at least one memory. The at least one processor configured to: determine a frequency of alternating-current power provided by a power grid to a hydrogen-production installation; determine an amount of power for the hydrogen-production installation to consume based on the frequency; and control hydrogen production at one or more electrolyzers of the hydrogen-production installation such that the one or more electrolyzers consume substantially the determined amount of power.

In another example, a non-transitory computer-readable medium is provided that has stored thereon instructions that, when executed by one or more processors, cause the one or more processors to: determine a frequency of alternating-current power provided by a power grid to a hydrogen-production installation; determine an amount of power for the hydrogen-production installation to consume based on the frequency; and control hydrogen production at one or more electrolyzers of the hydrogen-production installation such that the one or more electrolyzers consume substantially the determined amount of power.

In another example, an apparatus for controlling hydrogen production is provided. The apparatus includes: means for determining a frequency of alternating-current power provided by a power grid to a hydrogen-production installation; means for determining an amount of power for the hydrogen-production installation to consume based on the frequency; and means for controlling hydrogen production at one or more electrolyzers of the hydrogen-production installation such that the one or more electrolyzers consume substantially the determined amount of power.

In another example, a system for producing hydrogen is provided. The system includes: one or more electrolyzers configured to consume power and to produce hydrogen; and a controller configured to: one or both of: receive an indication of an amount of power produced by a power producer; or receive an indication of an amount of power consumed by a power consumer; determine an amount of power for the one or more electrolyzers to consume based on one or both of the amount of power produced by the power producer or the amount of power consumed of the power consumer; and control hydrogen production at the one or more electrolyzers such that the one or more electrolyzers consume substantially the determined amount of power.

In another example, a system for producing hydrogen is provided. The system includes: a connection to a power grid configured to receive alternating-current power from the power grid; one or more electrolyzers configured to consume power and to produce hydrogen; and a controller configured to: receive an indication of a frequency of the alternating-current power provided by the power grid; determine an amount of power for the one or more electrolyzers to consume based on the frequency; and control hydrogen production at the one or more electrolyzers such that the one or more electrolyzers consume substantially the determined amount of power.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for controlling production of hydrogen by one or more electrolyzers, according to various embodiments of the present disclosure.

FIG. 2 is a block diagram illustrating an example electrolyzer which may be controlled to produce hydrogen, according to various embodiments of the present disclosure.

FIG. 3 illustrates an example of a process for controlling hydrogen production, according to various embodiments of the present disclosure.

FIG. 4 illustrates another example of another process for controlling hydrogen production, according to various embodiments of the present disclosure.

FIG. 5 illustrates another example of another process for controlling hydrogen production, according to various embodiments of the present disclosure.

FIG. 6 illustrates an example computing-device architecture of an example computing device which can implement the various techniques described herein.

### DETAILED DESCRIPTION

An electrolyzer is a device that may use electrical power, in the form of direct-current (DC) power, to drive a chemical reaction. In the present disclosure, the term “electrolyzer” may refer to a device that may produce hydrogen by applying a DC current to water to separate hydrogen from oxygen.

The present disclosure describes systems, apparatuses, methods (also referred to herein as processes), and computer-readable media (collectively referred to as “systems and techniques”) for controlling hydrogen production based on power consumption at adjacent power consumers and/or power production at adjacent power producers. In the present disclosure, the term “adjacent” when referring to power consumers, power producers, and/or hydrogen-production installations may refer to the power consumers, the power producers, and/or the hydrogen-production installations being connected to the same power grid. Further, adjacent power consumers, power producers, and/or hydrogen-production installations may be connected to the power grid at respective locations that are related such that power production and/or consumption at one affects the others. For example, adjacent power consumers, power producers, and/or hydrogen-production installations may be connected on the same side of a distribution network from a utility. In some cases, a hydrogen-production installation may be collocated with one or more power consumers and/or one or more power producers, for example, in a shared site. In such cases, the hydrogen-production installation may, or may not, share a connection to the power grid with the one or more power consumers and/or the one or more power producers.

As an example of operation of the systems and techniques, a hydrogen-production installation may include one or more electrolyzers that may produce hydrogen. The systems and techniques may control hydrogen production of the one or more electrolyzers based on power consumption at adjacent power consumers and/or power production at adjacent power producers. For example, an entity may operate a site including a power consumer, a power producer, and one or more electrolyzers. The entity may control hydrogen production of the one or more electrolyzers based on power produced by the power producer and/or based on power consumed by the power consumer.

The systems and techniques may provide benefits to the power grid generally, e.g., by balancing consumption and/or production thereby aiding utilities in maintaining the stability of the power grid. Further, the systems and techniques, when operated by an entity operating both a hydrogen-production installation and a power consumer and/or a power producer may provide benefits to the entity. For example, the entity may, using the systems and techniques, have the option to produce hydrogen with excess power produced by the power producer rather than providing the excess power to the power grid. Additionally, or alternatively, the entity may, using the systems and techniques, produce hydrogen, using power from the power producer and not power from the power grid. Additionally, or alternatively, the entity may, using the systems and techniques, compensate for variability in the power consumed by the power consumer.

Various examples of the systems and techniques are described herein and will be discussed below with respect to the figures.

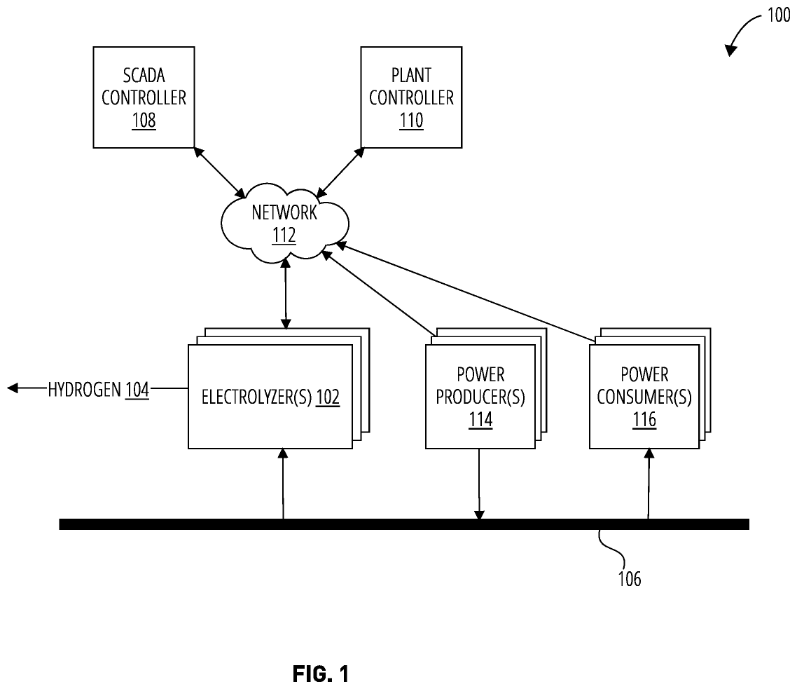

FIG. 1 is a block diagram illustrating a system 100 for controlling production of hydrogen 104 by one or more electrolyzers 102, according to various embodiments of the present disclosure. System 100 may control production of hydrogen 104 at electrolyzer 102 based on power produced by one or more power producers 114 and/or based on power consumed by one or more power consumers 116.

System 100 may be a hydrogen-production installation including electrolyzers 102. Electrolyzers 102 may be, or may include, any suitable electrolyzers, such as, for example, one or more proton exchange membrane (PEM) electrolyzers, one or more alkaline electrolyzers, solid-oxide electrolyzers, and/or one or more anion exchange membrane (AEM) electrolyzers. Electrolyzers 102 may receive electrical power (e.g., AC current) from grid connection 106 and may produce hydrogen 104.

System 100 includes supervisory control and data (SCADA) controller 108. SCADA controller 108 may monitor and control operations within system 100 (e.g., start up, shut down, restart of electrolyzers 102).

System 100 includes plant controller 110, which may receive commands (e.g., from an operator) and control operations within system 100 responsive to the commands. Plant controller 110 may coordinate the operation of electrolyzers 102 to cause commands to be executed appropriately. Control loops of plant controller 110 could be open-loop or closed-loop. For the closed-loop controls, plant controller 110 may continuously monitor feedback signals and adjust commands sent to the electrolyzers 102 accordingly.

Power producers 114 are optional in system 100. For example, in some embodiments, one or more power producers 114 may be included in system 100. Additionally, or alternatively, one or more power producers 114 may be collocated with system 100. Additionally, or alternatively, one or more power producers 114 may be separate from and remote from system 100; yet system 100 may interact with power producer 114 based on a connection to a common power grid. In any of such cases, power producer 114 may be adjacent to electrolyzer 102. In other embodiments, system 100 does not include or interact with power producers 114.

Power producers 114 may be, or may include, one or more energy storage systems and/or one or more energy production systems. As examples, power producers 114 may include energy sources based on solar energy, wind energy, geothermal energy, biomass energy, hydropower energy, nuclear energy, internal combustion, gas turbines, steam turbines.

Power consumers 116 are optional in system 100. For example, in some embodiments, one or more power consumers 116 may be included in system 100. Additionally, or alternatively, one or more power consumers 116 may be collocated with system 100. Additionally, or alternatively, one or more power consumers 116 may be separate from and remote from system 100; yet system 100 may interact with power consumers 116 based on a connection to a common power grid. In any of such cases, power consumer 116 may be adjacent to electrolyzer 102. In other embodiments, system 100 does not include or interact with power consumers 116.

Power producer 114 and/or power consumer 116 may include respective controllers (e.g., SCADA controllers). The respective controllers may provide respective indications of power produced and/or power consumed by power producer 114 and power consumer 116, respectively, to SCADA controller 108 and/or plant controller 110 (e.g., through network 112). The respective controllers may provide the indications whether power producer 114 and/or power consumer 116 are part of, collocated with, remote from and/or separate from system 100. Additionally, or alternatively, system 100 may determine indications of power produced and/or power consumed by power producer 114 and power consumer 116, respectively, by observing power at grid connection 106.

System 100 may include network 112, which may be any suitable network (e.g., an Ethernet network) for communicatively connecting SCADA controller 108, plant controller 110, electrolyzer 102, power producer 114, and/or power consumer 116.

Electrolyzers 102, power producers 114, and/or power consumers 116 may be connected to a power grid at grid connection 106. Grid connection 106 may be, or may be part of, an electrical distribution system. Grid connection 106 may be included in the hydrogen-production installation or grid connection 106 may be, at least partially, external to the hydrogen-production installation. Any or all of electrolyzers 102, power producers 114, and/or power consumers 116 may affect AC power (e.g., a frequency of the AC power) of the power grid based on their respective consumption and/or production of power.

System 100 (e.g., using SCADA controller 108 and/or plant controller 110) may control production of hydrogen 104 by electrolyzers 102 based on power produced by power producers 114 and/or based on power consumed power consumers 116 (whether system 100 includes power producers 114 and/or power consumers 116 or not). Additionally, or alternatively, system 100 may control production of hydrogen 104 by electrolyzer 102 based on power produced by power producers 114 and/or based on power consumed power consumers 116, e.g., in cases in which power producers 114 and/or power consumers 116 are not part of system 100 but are collocated with system 100 and/or in cases in which power producers 114 and/or power consumers 116 are remote from system 100.

Electrolyzers 102 may produce hydrogen 104 at a number of different rates. The rate at which electrolyzers 102 produce hydrogen 104 may govern an amount of electrical power electrolyzers 102 consume.

Hydrogen 104 produced at electrolyzers 102 may be output to, as examples, one or more compressors, one or more hydrogen storage tanks, and/or one or more pipelines. Production of hydrogen 104 by system 100 may, or may not, be directly tied to demand. For example, system 100 may vary a rate at which hydrogen 104 is produced independent of a rate at which hydrogen 104 is consumed. Thus, unlike utilities, which may generate electricity according to demand, system 100 may determine a rate at which to produce hydrogen 104 based on factors other than demand (e.g., based on power produced by one or more power producers 114 and/or based on power consumed by one or more power consumers 116).

System 100 (e.g., using SCADA controller 108 and/or plant controller 110) may control operations of electrolyzers 102 according to one or more operational criteria, which may be related to power produced by power producers 114 and/or based on power consumed power consumers 116.

For example, system 100 may operate according to a frequency-stabilization criteria to stabilize a frequency of AC power of the power grid. For example, system 100 may determine (e.g., measure) a frequency of AC power at grid connection 106. Further, system 100 may determine an amount of power for electrolyzer 102 to consume based on the frequency. For example, system 100 may cause electrolyzer 102 to increase an amount of power consumed in response to determining that a frequency of AC power at grid connection 106 is greater than a high-frequency threshold. And system 100 may cause electrolyzer 102 to decrease an amount of power consumed in response to determining that a frequency of AC power at grid connection 106 is less than a low-frequency threshold.

As another example, system 100 may operate according to a variability-stabilization criteria to stabilize a variability of power consumed by power consumer 116. For example, system 100 may determine (e.g., based on indications from power consumer 116) an amount of power consumed by power consumer 116. Further, system 100 may determine an amount of variability (e.g., change over time) in the amount of power consumed by power consumer 116. System 100 may determine an amount of power for electrolyzer 102 to consume based on the variability in the amount of power consumed by power consumer 116. For example, if power consumer 116 (e.g., over a short period of time) increases an amount of power consumed, system 100 may cause electrolyzer 102 to decrease an amount of power consumed (e.g., to compensate for the change in consumption of power consumer 116). And, if power consumer 116 (e.g., over a short period of time) decreases an amount of power consumed, system 100 may cause electrolyzer 102 to increase an amount of power consumed (e.g., to compensate for the change in consumption of power consumer 116).

As another example, system 100 may operate according to an adjacent-production criteria to produce hydrogen 104 using a power produced by power producer 114. For example, in some cases it may be desirable to generate hydrogen 104 using a certain percentage of power from a particular power source. For example, if an entity can produce hydrogen 104 using 90% or more “sustainable” or “green” energy, the entity may call the hydrogen 104 “sustainable” or “green.” Additionally, or alternatively, an entity may wish to produce hydrogen using power that the entity produces and not using power from the power grid. According to an example adjacent-production criteria, system 100 may cause electrolyzer 102 to consume an amount of power related to the amount of power produced by power producer 114. For example, system 100 may determine an amount of power produced by power producer 114 and cause electrolyzer 102 to consume the amount of power produced by power producer 114 (e.g., no more, no less than the amount of power produced by power producer 114). As another example, system 100 may cause electrolyzer 102 to consume 111% of power produced by power producer 114 (e.g., 100% of power produced by power producer 114 plus 11% of the amount of power produced by power producer 114 obtained from the power grid). As another example, system 100 may cause electrolyzer 102 to consume 50% of the amount of power produced by power producer 114 (e.g., such that the entity collectively provides 50% of the power that power producer 114 produces to the power grid and 50% is consumed by electrolyzer 102 to produce hydrogen 104).

As another example, system 100 may operate according to an excess-power-production criteria to produce 104 using an amount of power produced by power producer 114 that exceeds a threshold. For example, if an entity operates power producer 114 and electrolyzer 102, and the entity has a commitment to produce a certain amount of power, the entity may use power in excess of the certain amount to produce hydrogen 104 using electrolyzer 102. According to an example excess-power-production criteria, system 100 may cause electrolyzer 102 to consume an amount of power produced by power producer 114 that exceeds a threshold. For example, system 100 may determine an amount of power produced by power producer 114 and cause electrolyzer 102 to consume an amount of power produced by power producer 114 that exceeds the threshold. As another example, according to another example excess-power-production criteria, system 100 may cause electrolyzer 102 to consume an amount of power produced by power producer 114 less an amount of power consumed by power consumer 116 that exceeds a threshold. For example, system 100 may determine an amount of power produced by power producer 114 and an amount of power consumed by power consumer 116. System 100 may cause electrolyzer 102 to consume an amount of power produced by power producer 114 less the amount of power consumed by power consumer 116 that exceeds the threshold.

As another example, according to another example excess-power-production criteria, system 100 may cause electrolyzer 102 to consume a percentage of the amount of power produced by power producer 114 less an amount of power consumed by power consumer 116 that exceeds a threshold. For example, system 100 may determine an amount of power produced by power producer 114 and an amount of power consumed by power consumer 116. System 100 may cause electrolyzer 102 to consume a percentage of the amount of power produced by power producer 114 less the amount of power consumed by power consumer 116 that exceeds the threshold.

For example, power producer 114 may produce 100 megawatt hours (MWh) of power. Power consumer 116 may consume 25 MWh. The entity may have a commitment to deliver 50 MWh to the power grid. In a first example, system 100 may cause electrolyzer 102 to consume 100% of the power produced by power producer 114 (100 MWh), less the power consumed by power consumer 116 (25 MWh), that exceeds the threshold (e.g., 50 MWh). In the first example, system 100 may cause electrolyzer 102 to consume 25 MWh of power. In a second example, system 100 may cause electrolyzer 102 to consume 50% of the power produced by power producer 114 (100 MWh), less the power consumed by power consumer 116 (25 MWh), that exceeds the threshold (e.g., 50 MWh). In the second example, system 100 may cause electrolyzer 102 to consume 12.5 MWh of power. In the second example, system 100 may provide 12.5 MWh to the power grid in excess of the power produced according to the commitment. In a third example, system 100 may cause electrolyzer 102 to consume 200% of the power produced by power producer 114 (100 MWh), less the power consumed by power consumer 116 (25 MWh), that exceeds the threshold (e.g., 50 MWh). In the second example, system 100 may cause electrolyzer 102 to consume 50 MWh of power. In the second example, system 100 may draw 25 MWh from the power grid.

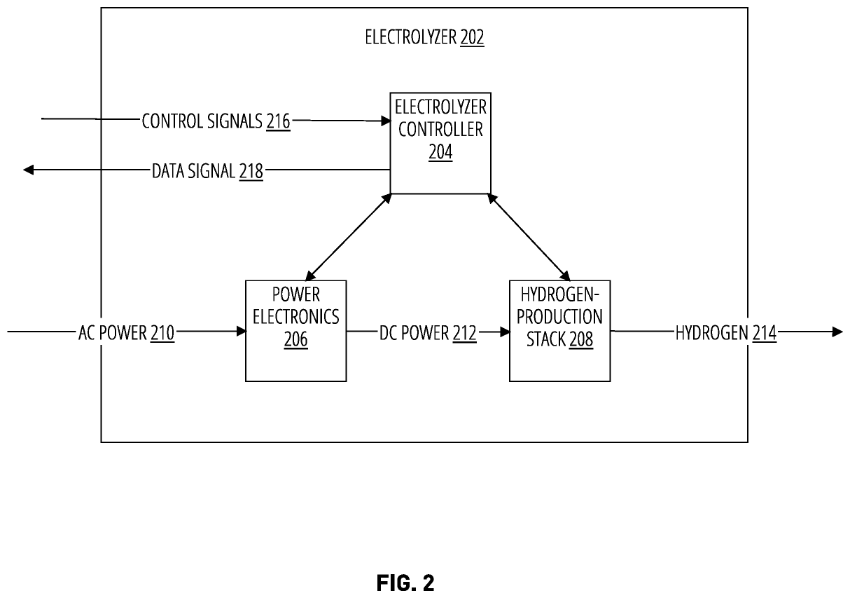

FIG. 2 is a block diagram illustrating an electrolyzer 202 which may be controlled to produce hydrogen 214, according to various embodiments of the present disclosure. Electrolyzer 202 may be an example of one of electrolyzers 102 of FIG. 1. Production of hydrogen 214 at electrolyzer 202 may be controlled based on power produced by a power producer and/or based on power consumed by a power consumer. Electrolyzer 202 may include an electrolyzer controller 204, a power electronics 206, and a hydrogen-production stack 208.

Power electronics 206 may receive AC power 210, e.g., from a power grid, (e.g., at a grid connection such as, grid connection 106 of FIG. 1). Power electronics 206 may include a pulse-width modifier (PWM) and a rectifier to convert AC power 210 to DC power 212. Power electronics 206 may additionally include a DC-DC converter to adjust DC power 212.

Hydrogen-production stack 208 may include one or more units for performing electrolysis, e.g., for using DC power 212 to drive a chemical reaction to produce hydrogen 214 from water. Hydrogen-production stack 208 may be able to produce hydrogen 214 at varying rates. A rate at which hydrogen-production stack 208 produces hydrogen 214 may determine an amount of DC power 212 consumed by hydrogen-production stack 208.

Electrolyzer controllers 204 may control operation hydrogen-production operations of power electronics 206 and/or hydrogen-production stack 208 responsive to control signals 216 (which control signals 216 may be received from a controller (such as, for example, SCADA controller 108 of FIG. 1 or plant controller 110 of FIG. 1), electrolyzer controller 204 may control operation of power electronics 206 and/or hydrogen-production stack 208.

Electrolyzer controller 204 may control operation of power electronics 206 and/or hydrogen-production stack 208 according to one or more electrolyzer-level operational criteria including, e.g., based on an amount of DC power 212 hydrogen-production stack 208 consumes, or based on an amount of hydrogen 214 hydrogen-production stack 208 generates. Electrolyzer controller 204 may provide data signal 218 to the controller.

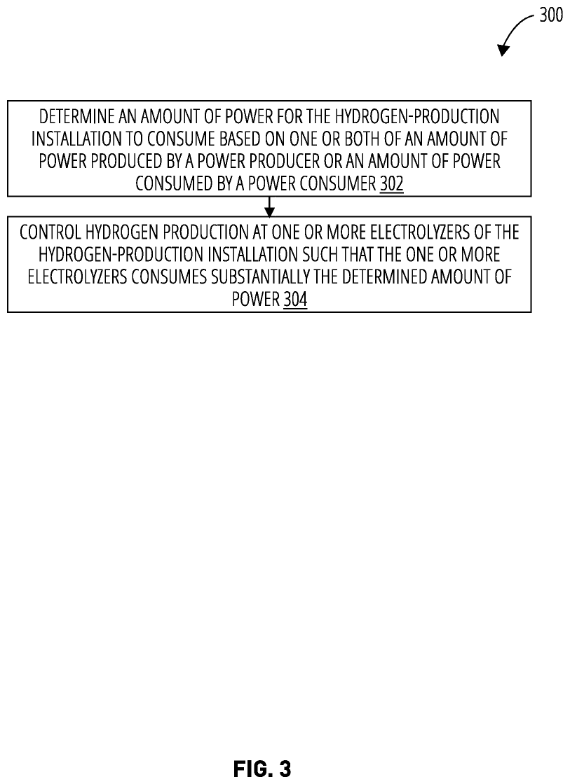

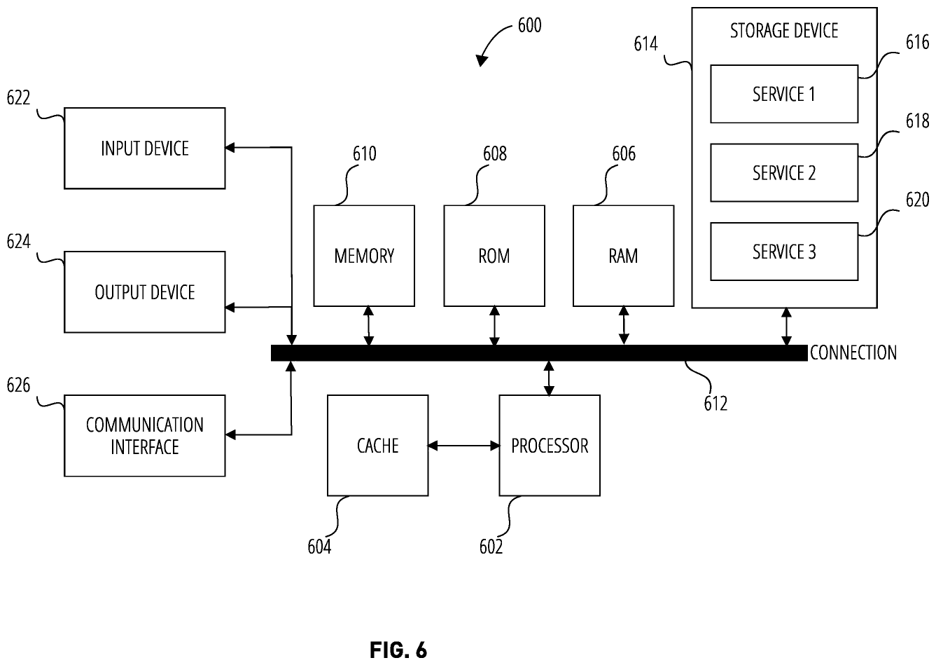

FIG. 3 illustrates an example of a process 300 for controlling hydrogen production based on power produced by a power producer and/or based on power consumed by a power consumer, according to various embodiments of the present disclosure. Process 300, or one or more operations thereof, may be performed by, or at, one or more elements of system 100 of FIG. 1, including, e.g., SCADA controller 108, plant controller 110, and/or electrolyzer 102, and/or at one or more elements of electrolyzer 202, including, e.g., electrolyzer controller 204. Additionally, or alternatively, process 300, or one or more operations thereof, may be performed by a computing device (or apparatus) or a component (e.g., a chipset, one or more processors, etc.) of the computing device. One or more of the operations of process 300 may be implemented as software components that are executed and run on one or more compute components or processors (e.g., processor 602 of FIG. 6, or other processor(s)).

At block 302, a computing device (or one or more components thereof) may determine an amount of power for a hydrogen-production installation to consume based on one or both of an amount of power produced by a power producer or an amount of power consumed by a power consumer. For example. SCADA controller 108 and/or plant controller 110 of FIG. 1 may determine an amount of power for electrolyzer(s) 102 based on an amount of power produced by power producer(s) 114 and/or an amount of power consumed by power consumer(s) 116.

At block 304, a computing device (or one or more components thereof) may control hydrogen production at one or more electrolyzers of the hydrogen-production installation such that the one or more electrolyzers consume substantially the determined amount of power. For example. SCADA controller 108 and/or plant controller 110 may control hydrogen production at electrolyzer(s) 102 to produce hydrogen based on the amount of power determined at block 302.

In some cases, block 302 may include determining an amount of power for each electrolyzer of the one or more electrolyzers to consume. Further, block 304 may include controlling hydrogen production at the one or more electrolyzers of the hydrogen-production installation comprises controlling hydrogen production at each electrolyzer of the one or more electrolyzers such that each electrolyzer of the one or more electrolyzers consume substantially the respective determined amount of power. In some cases, block 304 may include controlling a respective amount of hydrogen that each of the one or more electrolyzers produces such that the one or more electrolyzers consume substantially the determined amount of power.

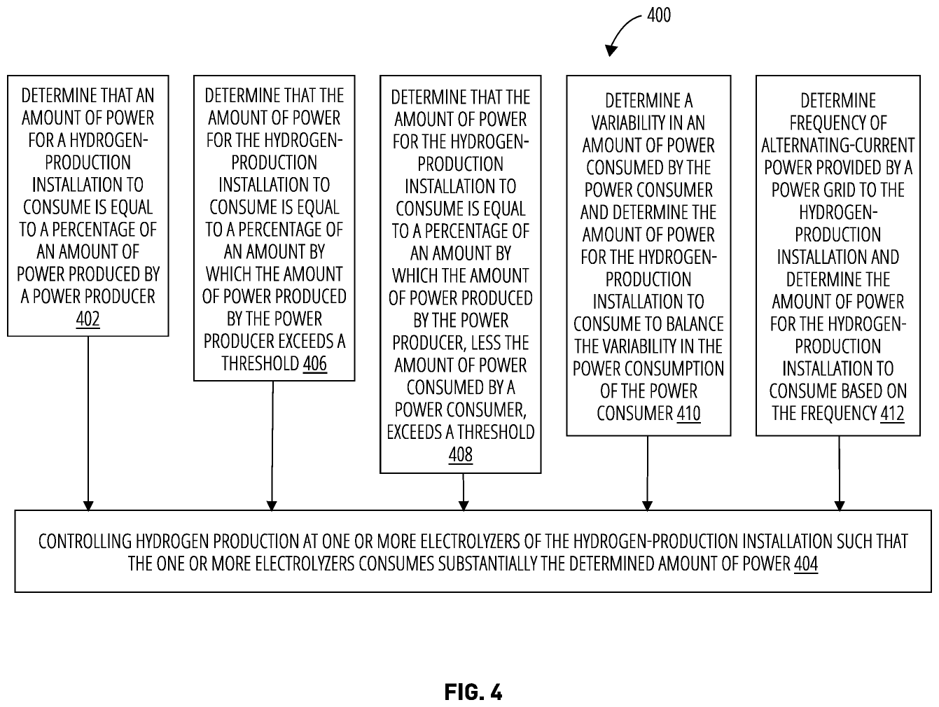

FIG. 4 illustrates an example of a process 400 for controlling hydrogen production based on power produced by a power producer and/or based on power consumed by a power consumer, according to various embodiments of the present disclosure. Process 400, or one or more operations thereof, may be performed by, or at, one or more elements of system 100 of FIG. 1, including, e.g., SCADA controller 108, plant controller 110, and/or electrolyzer 102, and/or at one or more elements of electrolyzer 202, including, e.g., electrolyzer controller 204. Additionally, or alternatively, process 400, or one or more operations thereof, may be performed by a computing device (or apparatus) or a component (e.g., a chipset, one or more processors, etc.) of the computing device. One or more of the operations of process 400 may be implemented as software components that are executed and run on one or more compute components or processors (e.g., processor 602 of FIG. 6, or other processor(s)).

Process 400 includes several optional blocks. For example, process 400 may include one or more of block 402, block 406, block 408, block 410 and/or block 412. Any one or more of block 402, block 406, block 408, block 410 and/or block 412 may be followed by block 404.

At block 402, a computing device (or one or more components thereof) may determine that the amount of power for the hydrogen-production installation to consume is equal to a percentage of the amount of power produced by the power producer. For example, SCADA controller 108 and/or plant controller 110 of FIG. 1 may determine an amount of power for electrolyzer(s) 102 to consume. The amount of power may be equal to a percentage of an amount of power produced by power producer 114.

At block 406, the computing device (or one or more components thereof) may determine that the amount of power for the hydrogen-production installation to consume is equal to a percentage of an amount by which the amount of power produced by the power producer exceeds a threshold. For example, SCADA controller 108 and/or plant controller 110 of FIG. 1 may determine an amount of power for electrolyzer(s) 102 to consume. The amount of power may be equal to a percentage of an amount by which the amount of power produced by power producer 114 exceeds a threshold.

At block 408, the computing device (or one or more components thereof) may determine that the amount of power for the hydrogen-production installation to consume is equal to a percentage of the amount of power produced by the power producer less the amount of power consumed by the power consumer. For example, SCADA controller 108 and/or plant controller 110 of FIG. 1 may determine an amount of power for electrolyzer(s) 102 to consume. The amount of power may be equal to a percentage of the amount of power produced by the power producer 114 less the amount of power consumed by the power consumer 116.

At block 410, the computing device (or one or more components thereof) may determine that the amount of power for the hydrogen-production installation to consume is equal to a percentage of an amount by which the amount of power produced by the power producer, less the amount of power consumed by the power consumer, exceeds a threshold. For example, SCADA controller 108 and/or plant controller 110 of FIG. 1 may determine an amount of power for electrolyzer(s) 102 to consume. The amount of power may be equal to a percentage of an amount by which the amount of power produced by the power producer 114, less the amount of power consumed by the power consumer 116, exceeds a threshold.

At block 412, the computing device (or one or more components thereof) may determine a frequency of alternating-current power provided by a power grid to the hydrogen-production installation and determine the amount of power for the hydrogen-production installation to consume is further based on the frequency.

For example, SCADA controller 108 and/or plant controller 110 of FIG. 1 may determine a frequency of AC power provided to system 100 by grid connection 106. SCADA controller 108 and/or plant controller 110 may determine an amount of power for electrolyzer(s) 102 to consume based on the frequency.

Process 400 may, additionally, or alternatively, include determining a variability in the amount of power consumed by the power consumer and determining the amount of power for the hydrogen-production installation to consume to balance the variability in the amount of power consumed by the power consumer.

At block 404, the computing device (or one or more components thereof) may control hydrogen production at one or more electrolyzers of the hydrogen-production installation such that the one or more electrolyzers consume substantially the determined amount of power. For example. SCADA controller 108 and/or plant controller 110 may control hydrogen production at electrolyzer(s) 102 to produce hydrogen based on the amount of power determined at block one or more of block 402, block 406, block 408, block 410, and/or block 412.

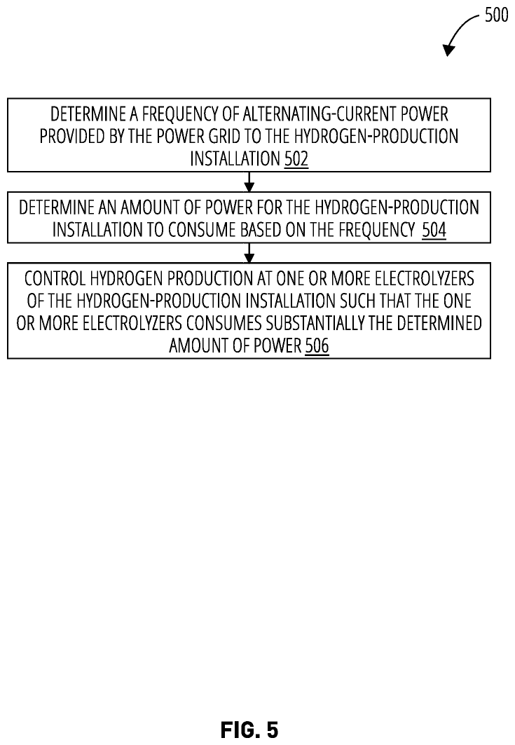

FIG. 5 illustrates an example of a process 500 for controlling hydrogen production based on power produced by a power producer and/or based on power consumed by a power consumer, according to various embodiments of the present disclosure. Process 500, or one or more operations thereof, may be performed by, or at, one or more elements of system 100 of FIG. 1, including, e.g., SCADA controller 108, plant controller 110, and/or electrolyzer 102, and/or at one or more elements of electrolyzer 202, including, e.g., electrolyzer controller 204. Additionally, or alternatively, process 500, or one or more operations thereof, may be performed by a computing device (or apparatus) or a component (e.g., a chipset, one or more processors, etc.) of the computing device. One or more of the operations of process 500 may be implemented as software components that are executed and run on one or more compute components or processors (e.g., processor 602 of FIG. 6, or other processor(s)).

At block 502, a computing device (or one or more components thereof) may determine a frequency of alternating-current power provided by a power grid to a hydrogen-production installation. For example, SCADA controller 108 and/or plant controller 110 of FIG. 1 may determine a frequency of AC power provided to system 100 by grid connection 106.

At block 504, the computing device (or one or more components thereof) may determine an amount of power for the hydrogen-production installation to consume based on the frequency. For example, SCADA controller 108 and/or plant controller 110 may determine an amount of power for electrolyzer(s) 102 to consume based on the frequency.

At block 506, the computing device (or one or more components thereof) may control hydrogen production at one or more electrolyzers of the hydrogen-production installation such that the one or more electrolyzers consume substantially the determined amount of power. For example. SCADA controller 108 and/or plant controller 110 may control hydrogen production at electrolyzer(s) 102 to produce hydrogen based on the amount of power determined at block 504.

In some cases, the computing device (or one or more components thereof) may determine to decrease an amount of power the hydrogen-production installation is consuming based on the frequency being less than a low threshold. In other cases, the computing device (or one or more components thereof) may determine to increase an amount of power the hydrogen-production installation is consuming based on the frequency being greater than a high threshold.

In some cases, process 500 may include determining the amount of power for the hydrogen-production installation to consume further based on one or both of an amount of power produced by a power producer connected to the power grid or an amount of power consumed by a power consumer connected to the power grid. For example, SCADA controller 108 and/or 110/ may additionally determine an amount of power produced by power producer 114 and/or an amount of power consumed by power consumer 116. SCADA controller 108 and/or plant controller 110 may determine the amount of power for electrolyzer(s) 102 to consume based on the amount of power produced by power producer 114 and/or the amount of power consumed by power consumer 116.

Additionally, or alternatively, the computing device (or one or more components thereof) may determine a variability in an amount of power consumed by a power consumer connected to the power grid and determine the amount of power for the hydrogen-production installation to consume to balance the variability in the amount of power consumed by a power consumer,

In some examples, the methods described herein (e.g., process 300 of FIG. 3, process 400 of FIG. 4, process 500 of FIG. 5, and/or other methods described herein) can be performed by a computing device or apparatus. In one example, one or more of the methods can be performed by system 100 of FIG. 1, SCADA controller 108 of FIG. 1, plant controller 110 of FIG. 1, and/or electrolyzer controller 204 of FIG. 2. In another example, one or more of the methods can be performed by one or more elements of computing-device architecture 600 shown in FIG. 6. For instance, a computing device with computing-device architecture 600 shown in FIG. 6 can include the components of the system 100, and/or electrolyzer 202, and can implement the operations of the process 300, process 400, process 500, and/or other process described herein.

The computing device can include any suitable device, a desktop computer, a server computer, and/or any other computing device with the resource capabilities to perform the processes described herein, including process 300, process 400, process 500, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 300, process 400, process 500, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 300, process 400, process 500, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 6 illustrates an example computing-device architecture 600 of an example computing device which can implement the various techniques described herein. In some examples, the computing device can include a personal computer, a laptop computer, a server computer, or other device. The components of computing-device architecture 600 are shown in electrical communication with each other using connection 612, such as a bus. The example computing-device architecture 600 includes a processing unit (CPU or processor) 602 and computing device connection 612 that couples various computing device components including computing device memory 610, such as read only memory (ROM) 608 and random-access memory (RAM) 606, to processor 602.

Computing-device architecture 600 can include a cache of high-speed memory connected directly with, in close proximity to, or integrated as part of processor 602. Computing-device architecture 600 can copy data from memory 610 and/or the storage device 614 to cache 604 for quick access by processor 602. In this way, the cache can provide a performance boost that avoids processor 602 delays while waiting for data. These and other modules can control or be configured to control processor 602 to perform various actions. Other computing device memory 610 may be available for use as well. Memory 610 can include multiple different types of memory with different performance characteristics. Processor 602 can include any general-purpose processor and a hardware or software service, such as service 1 616, service 2 618, and service 3 620 stored in storage device 614, configured to control processor 602 as well as a special-purpose processor where software instructions are incorporated into the processor design. Processor 602 may be a self-contained system, containing multiple cores or processors, a bus, memory controller, cache, etc. A multi-core processor may be symmetric or asymmetric.

To enable user interaction with the computing-device architecture 600, input device 622 can represent any number of input mechanisms, such as a microphone for speech, a touch-sensitive screen for gesture or graphical input, keyboard, mouse, motion input, speech and so forth. Output device 624 can also be one or more of a number of output mechanisms known to those of skill in the art, such as a display, projector, television, speaker device, etc. In some instances, multimodal computing devices can enable a user to provide multiple types of input to communicate with computing-device architecture 600. Communication interface 626 can generally govern and manage the user input and computing device output. There is no restriction on operating on any particular hardware arrangement and therefore the basic features here may easily be substituted for improved hardware or firmware arrangements as they are developed.

Storage device 614 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 606, read only memory (ROM) 608, and hybrids thereof. Storage device 614 can include services 616, 618, and 620 for controlling processor 602. Other hardware or software modules are contemplated. Storage device 614 can be connected to the computing device connection 612. In one embodiment, a hardware module that performs a particular function can include the software component stored in a computer-readable medium in connection with the necessary hardware components, such as processor 602, connection 612, output device 624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Embodiments of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, embodiments of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various embodiments of this disclosure, the term “device” is not limited to a specific configuration, type, or number of objects. Additionally, the term “system” is not limited to multiple components or specific embodiments. For example, a system may be implemented on one or more printed circuit boards or other substrates and may have movable or static components. While the below description and examples use the term “system” to describe various embodiments of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, embodiments of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and embodiments of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative embodiments of the disclosure include:

Embodiment 1. A method for controlling hydrogen production, the method comprising: determining an amount of power for a hydrogen-production installation to consume based on one or both of an amount of power produced by a power producer or an amount of power consumed by a power consumer; and controlling hydrogen production at one or more electrolyzers of the hydrogen-production installation such that the one or more electrolyzers consume substantially the determined amount of power.

Embodiment 2. The method of embodiment 1, wherein determining the amount of power for the hydrogen-production installation to consume comprises determining that the amount of power for the hydrogen-production installation to consume is equal to a percentage of the amount of power produced by the power producer.

Embodiment 3. The method of any one of embodiments 1 or 2, wherein determining the amount of power for the hydrogen-production installation to consume comprises determining that the amount of power for the hydrogen-production installation to consume is equal to a percentage of an amount by which the amount of power produced by the power producer exceeds a threshold.

Embodiment 4. The method of any one of embodiments 1 to 3, wherein determining the amount of power for the hydrogen-production installation to consume comprises determining that the amount of power for the hydrogen-production installation to consume is equal to a percentage of the amount of power produced by the power producer less the amount of power consumed by the power consumer.

Embodiment 5. The method of any one of embodiments 1 to 4, wherein determining the amount of power for the hydrogen-production installation to consume comprises determining that the amount of power for the hydrogen-production installation to consume is equal to a percentage of an amount by which the amount of power produced by the power producer, less the amount of power consumed by the power consumer, exceeds a threshold.

Embodiment 6. The method of any one of embodiments 1 to 5, wherein: the method further comprises determining a variability in the amount of power consumed by the power consumer; and determining the amount of power for the hydrogen-production installation to consume comprises determining the amount of power for the hydrogen-production installation to consume to balance the variability in the amount of power consumed by the power consumer.

Embodiment 7. The method of any one of embodiments 1 to 6, wherein: the method further comprises determining a frequency of alternating-current power provided by a power grid to the hydrogen-production installation; and determining the amount of power for the hydrogen-production installation to consume is further based on the frequency.

Embodiment 8. The method of any one of embodiments 1 to 7, wherein: the method further comprises determining an amount of power for each electrolyzer of the one or more electrolyzers to consume; and controlling hydrogen production at the one or more electrolyzers of the hydrogen-production installation comprises controlling hydrogen production at each electrolyzer of the one or more electrolyzers such that each electrolyzer of the one or more electrolyzers consume substantially the respective determined amount of power.

Embodiment 9. The method of any one of embodiments 1 to 8, wherein controlling hydrogen production at the one or more electrolyzers of the hydrogen-production installation comprises controlling a respective amount of hydrogen that each of the one or more electrolyzers produces such that the one or more electrolyzers consume substantially the determined amount of power.

Embodiment 10. A method for controlling hydrogen production, the method comprising: determining a frequency of alternating-current power provided by a power grid to a hydrogen-production installation; determining an amount of power for the hydrogen-production installation to consume based on the frequency; and controlling hydrogen production at one or more electrolyzers of the hydrogen-production installation such that the one or more electrolyzers consume substantially the determined amount of power.

Embodiment 11. The method of embodiment 10, further comprising one of: determining to decrease an amount of power the hydrogen-production installation is consuming based on the frequency being less than a low threshold; or determining to increase an amount of power the hydrogen-production installation is consuming based on the frequency being greater than a high threshold.

Embodiment 12. The method of any one of embodiments 10 or 11, wherein determining the amount of power for the hydrogen-production installation to consume is further based on one or both of an amount of power produced by a power producer connected to the power grid or an amount of power consumed by a power consumer connected to the power grid.

Embodiment 13. The method of any one of embodiments 10 to 12, wherein: the method further comprises determining a variability in an amount of power consumed by a power consumer connected to the power grid; and determining the amount of power for the hydrogen-production installation to consume comprises determining the amount of power for the hydrogen-production installation to consume to balance the variability in the amount of power consumed by a power consumer.

Embodiment 14. A system for producing hydrogen, the system comprising: one or more electrolyzers configured to consume power and to produce hydrogen; and a controller configured to: one or both of: receive an indication of an amount of power produced by a power producer; or receive an indication of an amount of power consumed by a power consumer; determine an amount of power for the one or more electrolyzers to consume based on one or both of the amount of power produced by the power producer or the amount of power consumed of the power consumer; and control hydrogen production at the one or more electrolyzers such that the one or more electrolyzers consume substantially the determined amount of power.

Embodiment 15. The system of embodiment 14, wherein the system comprises one or both of the power producer or the power consumer.

Embodiment 16. The system of any one of embodiments 14 or 15, wherein the controller is further configured to: determine a variability in the amount of power consumed by a power consumer; and determine the amount of power for the one or more electrolyzers to consume further based on the variability.

Embodiment 17. The system of any one of embodiments 14 to 16, wherein the controller is further configured to: receive an indication of a frequency of alternating-current power provided by a power grid to the one or more electrolyzers; and determine the amount of power for the one or more electrolyzers to consume further based on the frequency.

Embodiment 18. A system for producing hydrogen, the system comprising: a connection to a power grid configured to receive alternating-current power from the power grid; one or more electrolyzers configured to consume power and to produce hydrogen; and a controller configured to: receive an indication of a frequency of the alternating-current power provided by the power grid; determine an amount of power for the one or more electrolyzers to consume based on the frequency; and control hydrogen production at the one or more electrolyzers such that the one or more electrolyzers consume substantially the determined amount of power.

Embodiment 19. The system of embodiment 18, wherein the controller is further configured to: one or both of: receive an indication of an amount of power produced by a power producer; or receive an indication of an amount of power consumed by a power consumer; and determine the amount of power for the one or more electrolyzers to consume further based on one or both of the amount of power produced by the power producer or the amount of power consumed of the power consumer.

Embodiment 20. The system of any one of embodiments 18 or 19, wherein the controller is further configured to: determine a variability in an amount of power consumed by a power consumer connected to the power grid; and determine the amount of power for the one or more electrolyzers to consume further based on the variability.

Embodiment 21. A method for controlling hydrogen production, the method comprising: determining an amount of power for a hydrogen-production installation to consume based on an amount of power produced by a power producer; and controlling hydrogen production at one or more electrolyzers of the hydrogen-production installation such that the one or more electrolyzers consume substantially the determined amount of power.

Embodiment 22. A method for controlling hydrogen production, the method comprising: determining an amount of power for a hydrogen-production installation to consume based on an amount of power consumed by a power consumer; and controlling hydrogen production at one or more electrolyzers of the hydrogen-production installation such that the one or more electrolyzers consume substantially the determined amount of power.

Embodiment 23. A non-transitory computer-readable storage medium having stored thereon instructions that, when executed by at least one processor, cause the at least one processor to perform operations according to any of embodiments 1 to 13 or 21 to 22.

Embodiment 24. An apparatus for providing virtual content for display, the apparatus comprising one or more means for perform operations according to any of embodiments 1 to 13 or 21 to 22.

What is claimed is:

1. A method for controlling hydrogen production, the method comprising:
determining an amount of power for a hydrogen-production installation to consume based on one or both of an amount of power produced by a power producer or an amount of power consumed by a power consumer; and
controlling hydrogen production at one or more electrolyzers of the hydrogen-production installation such that the one or more electrolyzers consume substantially the determined amount of power.

2. The method of claim 1, wherein determining the amount of power for the hydrogen-production installation to consume comprises determining that the amount of power for the hydrogen-production installation to consume is equal to a percentage of the amount of power produced by the power producer.

3. The method of claim 1, wherein determining the amount of power for the hydrogen-production installation to consume comprises determining that the amount of power for the hydrogen-production installation to consume is equal to a percentage of an amount by which the amount of power produced by the power producer exceeds a threshold.

4. The method of claim 1, wherein determining the amount of power for the hydrogen-production installation to consume comprises determining that the amount of power for the hydrogen-production installation to consume is equal to a percentage of the amount of power produced by the power producer less the amount of power consumed by the power consumer.

5. The method of claim 1, wherein determining the amount of power for the hydrogen-production installation to consume comprises determining that the amount of power for the hydrogen-production installation to consume is equal to a percentage of an amount by which the amount of power produced by the power producer, less the amount of power consumed by the power consumer, exceeds a threshold.

6. The method of claim 1, wherein:
the method further comprises determining a variability in the amount of power consumed by the power consumer; and
determining the amount of power for the hydrogen-production installation to consume comprises determining the amount of power for the hydrogen-production installation to consume to balance the variability in the amount of power consumed by the power consumer.

7. The method of claim 1, wherein:
the method further comprises determining a frequency of alternating-current power provided by a power grid to the hydrogen-production installation; and
determining the amount of power for the hydrogen-production installation to consume is further based on the frequency.

8. The method of claim 1, wherein:
the method further comprises determining an amount of power for each electrolyzer of the one or more electrolyzers to consume; and
controlling hydrogen production at the one or more electrolyzers of the hydrogen-production installation comprises controlling hydrogen production at each electrolyzer of the one or more electrolyzers such that each electrolyzer of the one or more electrolyzers consume substantially the respective determined amount of power.

9. The method of claim 1, wherein controlling hydrogen production at the one or more electrolyzers of the hydrogen-production installation comprises controlling a respective amount of hydrogen that each of the one or more electrolyzers produces such that the one or more electrolyzers consume substantially the determined amount of power.

10. A method for controlling hydrogen production, the method comprising:
determining a frequency of alternating-current power provided by a power grid to a hydrogen-production installation;
determining an amount of power for the hydrogen-production installation to consume based on the frequency; and
controlling hydrogen production at one or more electrolyzers of the hydrogen-production installation such that the one or more electrolyzers consume substantially the determined amount of power.

11. The method of claim 10, further comprising one of:
determining to decrease an amount of power the hydrogen-production installation is consuming based on the frequency being less than a low threshold; or
determining to increase an amount of power the hydrogen-production installation is consuming based on the frequency being greater than a high threshold.

12. The method of claim 10, wherein determining the amount of power for the hydrogen-production installation to consume is further based on one or both of an amount of power produced by a power producer connected to the power grid or an amount of power consumed by a power consumer connected to the power grid.

13. The method of claim 10, wherein:
the method further comprises determining a variability in an amount of power consumed by a power consumer connected to the power grid; and
determining the amount of power for the hydrogen-production installation to consume comprises determining the amount of power for the hydrogen-production installation to consume to balance the variability in the amount of power consumed by a power consumer.

14. A system for producing hydrogen, the system comprising:
one or more electrolyzers configured to consume power and to produce hydrogen; and
a controller configured to:
one or both of:
receive an indication of an amount of power produced by a power producer; or
receive an indication of an amount of power consumed by a power consumer;
determine an amount of power for the one or more electrolyzers to consume based on one or both of the amount of power produced by the power producer or the amount of power consumed of the power consumer; and
control hydrogen production at the one or more electrolyzers such that the one or more electrolyzers consume substantially the determined amount of power.

15. The system of claim 14, wherein the system comprises one or both of the power producer or the power consumer.

16. The system of claim 14, wherein the controller is further configured to:
determine a variability in the amount of power consumed by a power consumer; and
determine the amount of power for the one or more electrolyzers to consume further based on the variability.

17. The system of claim 14, wherein the controller is further configured to:
receive an indication of a frequency of alternating-current power provided by a power grid to the one or more electrolyzers; and
determine the amount of power for the one or more electrolyzers to consume further based on the frequency.

18. A system for producing hydrogen, the system comprising:
a connection to a power grid configured to receive alternating-current power from the power grid;
one or more electrolyzers configured to consume power and to produce hydrogen; and
a controller configured to:
receive an indication of a frequency of the alternating-current power provided by the power grid;
determine an amount of power for the one or more electrolyzers to consume based on the frequency; and
control hydrogen production at the one or more electrolyzers such that the one or more electrolyzers consume substantially the determined amount of power.

19. The system of claim 18, wherein the controller is further configured to:
one or both of:
receive an indication of an amount of power produced by a power producer; or
receive an indication of an amount of power consumed by a power consumer; and
determine the amount of power for the one or more electrolyzers to consume further based on one or both of the amount of power produced by the power producer or the amount of power consumed of the power consumer.

20. The system of claim 18, wherein the controller is further configured to:
determine a variability in an amount of power consumed by a power consumer connected to the power grid; and
determine the amount of power for the one or more electrolyzers to consume further based on the variability.
